(19) United States
(12) Patent Application Publication
(10) Pub. No.: US 2023/0070815 A1
(43) Pub. Date: Mar. 9, 2023

(54) Assembled door frame

(71) Applicant: Ningbo Tengyu Metal Product Co., Ltd., Ningbo City (CN)

(72) Inventors: Peike ZHANG, Ningbo City (CN); Junhua JIANG, Ningbo City (CN); Liujian ZHANG, Ningbo City (CN); Yechen XU, Ningbo City (CN); Zhewei WU, Ningbo City (CN); Xiaobin HE, Ningbo City (CN)

(21) Appl. No.: 17/903,667

(22) Filed: Sep. 6, 2022

(30) Foreign Application Priority Data
Sep. 6, 2021 (CN) 202111038135.3

(51) Int. Cl. E06B 3/964; E06B 3/72; E06B 3/54

(52) U.S. Cl. CPC E06B 3/9645; E06B 3/728; E06B 3/5454; E06B 3/9644; E06B 2003/7074

(57) ABSTRACT

An assembled door frame is provided, including multiple of side frames spliced together, where every adjacent two of the side frames spliced at right angle are connected via a corner connector assembly. The corner connector assembly is arranged inside the every adjacent two of the side frames spliced at right angle. The corner connector assembly includes a corner connector and fixing bolts, and one of the every adjacent two of side frames spliced at right angle is fixed on the corner connector by the fixing bolts. In the embodiments, the side frames are spliced directly together through the respective corner connector assemblies each including the corner connector and the fixing bolts. On one hand, the corner connector and the fixing bolts are each disposed within the corresponding side frame, such that the original external structure of the side frames will not be changed after the side frames are spliced together, thereby reducing assembly errors of the door frame caused by using the connecting structure. On the other hand, the direct splicing of the side frames is achieved merely by two types of members that are the corner connector and the fixing bolts. So compared with the prior art, a welding process of the side frames is not required, the structure thereof is simple, and the mounting thereof is convenient.

### CROSS REFERENCE TO RELATED APPLICATION

This patent application claims the benefit and priority of Chinese Patent Application No. 202111038135.3, entitled “ASSEMBLED DOOR FRAME” filed on Sep. 6, 2021, the disclosure of which is incorporated by reference herein in its entirety as part of the present application.

### TECHNICAL FIELD

The present disclosure relates to the technical field of door and window structures, and more particularly, to an assembled door frame.

### BACKGROUND ART

A door frame can be used as a transition layer between a wall body and a door, and plays a role of fixing a surrounding wall body and preventing the surrounding wall body from collapsing. Because the shape of the door board is various, the material of the door frame is generally selected from a material with strong plasticity, such as wood or plastic. In prior art, the door frame is generally formed by welding and assembling four frames. When mounting a window frame, a worker usually first assembles the frames in the outdoors by welding to form the door frame, and then takes it to the user's room for indoor installation.

However, the welded door frame body is easily limited by the surrounding environment due to the large dimension thereof, so it is troublesome and not convenient enough during transferring the door frame. And, the traditional welding method is irreversible. When the joining angle of the door frame is deviated or other unexpected situations occur, the door frame cannot be disassembled for adjustment.

With regard to this technical problem, Chinese Patent Application Publication No. CN1635256A discloses an assembled door/window cover, including a transverse cover plate, vertical cover plates and a door line, where two ends of a plate face of the transverse cover plate are provided with positioning grooves, and the front of the plate face is provided with a door line combination groove. The top of each of the vertical sleeve plates is provided with a mortise, the side of which is provided with a door line combination groove. The mortise on the top of each of the vertical sleeve plates can be tightly combined with the positioning groove on the horizontal sleeve plate, and the door line combination groove on the side of each of the vertical sleeve plates can be tightly combined with the insertion groove on the door line. A combination telescopic groove is provided in the door line combination grooves on the transverse cover plate and the vertical cover plates. Compared with the prior art, the welding is replaced by means of the integral plug-in connection structure design, so the construction is less difficult, and the installation is convenient. However, the assembly strength of the plug-in connection structure can not be ensured by the design of the plug-in connection structure, which directly affects the structural stability of the door frame.

In this regard, Chinese Patent No. CN211500288U discloses an assembled window frame that is used in buildings and has a reinforcing effect. The assembled window frame includes transverse rods, vertical rods and a separation rod. The number of the transverse rods of the door frame is two, and the vertical rods are provided on two sides between the two transverse rods. A separation rod is provided at a proximity top position between the two vertical rods, a second groove is provided on both sides of the partition rod of the door frame, a first groove is provided at a proximity top position of one side close to the separation rod of each of the two vertical rods, and a sleeve is fixedly mounted inside the first groove. A spring is provided inside the sleeve, and a fixing block is fixedly connected to one side of the spring away from the sleeve. Compared with the prior art, by means of the design of a plastic limiting plate and a limiting rod, a proximity bottom position of one end of the limiting rod away from the corresponding transverse rod can be clamped between two plastic limiting plates, so that the connection is stable. And, by means of the design of screws, threaded holes and threaded slots, the screws can be used to reinforce the stable connection between a fixing plate and a vertical rod, thereby improving stability of the connection. However, although the overall stability of the door frame can be enhanced by arranging external connection components for assembling the door frame, the assembling precision of the door frame is also seriously affected. Specifically, after the external connection components are assembled, due to the external arrangement of the external connection components, the edge size of the door frame is slightly greater than the preset size, thereby resulting in inconsistency between the actual size and the preset size, which will have a serious impact on the assembly of the door frame. And, the external connection components are not aesthetic.

Therefore, with respect to the described problems existing in the prior art, it is necessary to improve the structure design thereof, so as to provide an assembled door frame which can ensure the simplicity and convenience of assembly and does not affect the overall assembly accuracy of the door frame.

### SUMMARY

The purpose of the present disclosure is to solve the described technical problem, and to provide an assembled door frame. By improving the structure design thereof, the overall assembly accuracy of the door frame is not affected while the simple assembly and the convenient installation are ensured.

To achieve the described object, the present disclosure provides the following solution: providing an assembled door frame, including a plurality of side frames spliced together, wherein every adjacent two of the side frames spliced at right angle are connected via a corner connector assembly; the corner connector assembly is arranged inside the every adjacent two of the side frames spliced at right angle; the corner connector assembly comprises a corner connector and fixing bolts, and one of the every adjacent two of side frames spliced at right angle is fixed on the corner connector by the fixing bolts.

In some embodiments, the corner connector is fixed inside a first side frame of the every adjacent two of side frames spliced at right angle; and a second side frame of the every adjacent two of side frames is fixed on the corner connector by the fixing bolts.

In some embodiments, first bolt holes are formed in the corner connector, and second bolt holes are formed in the second side frame; each of the fixing bolts is connected to the second side frame through a corresponding one of the second bolt holes, so as to connect to a corresponding one of the first bolt holes to fix the second side frame on the corner connector.

In some embodiments, a bolt connection piece is provided on the second side frame, the bolt connection piece is recessed towards an inside of the second side frame, and the second bolt holes are provided on the bolt connection piece.

In some embodiments, the corner connector is of a right-angle fixing structure; the every adjacent two of the side frames spliced at right angle are respectively provided with bolt holes, and the every adjacent two of the side frames are fixed on two right-angle sides of the corner connector respectively by the fixing bolts each of which passes through a corresponding one of the bolt holes.

In some embodiments, a seam decorative cover is provided on a splicing seam of the every adjacent two of the side frames spliced at right angle.

In some embodiments, an inner side of each of the side frames is provided with a groove for receiving a sheet material.

In some embodiments, a transom is provided between two of the side frames which are parallel to each other; two ends of the transom are plugged into the two of the side frames respectively; and the transom is provided with a bidirectional groove having an H-shaped cross section, so as to enable the sheet material to plug into and fix with the bidirectional groove.

In some embodiments, the groove on each of the side frames and the bidirectional groove of the transom are respectively provided with an U-shaped adhesive strip for fixing the sheet material.

In some embodiments, each of the side frames is made of an iron profile, and the transom is made of an aluminum profile.

The present disclosure achieves the following technical effects with respect to the prior art.

(1) In the embodiments, the corner connector assembly used for splicing side frames at right angle is disposed inside the side frames, so that the side frames are not added an external structure after the side frames are spliced together. So, it is ensured that the original dimensions of the side frames are practically not changed, thereby ensuring the assembly accuracy of the formed door frame.

(2) In the embodiments, the side frames are spliced directly together through the respective corner connector assemblies each including the corner connector and the fixing bolts. On one hand, the corner connector and the fixing bolts are each disposed within the corresponding side frame, such that the original external structure of the side frames will not be changed after the side frames are spliced together, thereby reducing assembly errors of the door frame caused by using the connecting structure. On the other hand, the direct splicing of the side frames is achieved merely by two types of members that are the corner connector and the fixing bolts. So, compared with the prior art, a welding process of the side frames is not required, the structure thereof is simple, and the mounting thereof is convenient.

(3) In the embodiments, each of the side frames of the door frame is made of an iron profile, and the strength of the iron profile such as tensile strength, twisting resistance, and bending resistance is stronger than that of the aluminum profile. So, the iron profile with the same strength as the aluminum profile can have a thinner wall thickness, thereby reducing the weight and the cost. The transom has a relatively complex structure, the production of the transom is suitable for using an aluminum extrusion production process, and the transom is easily machined. Therefore, the overall door frame takes advantage of the respective advantages of the iron profile and the aluminum profile, which effectively reduces the manufacturing cost of the door frame while the stability thereof is improved.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a structural schematic diagram of a door frame according to the embodiments of the present disclosure after assembly;

FIG. 2 is an exploded view of a door frame structure according to embodiments of the present disclosure;

FIG. 3 is a partial enlarged view of detail A in FIG. 2;

FIG. 4 is a sectional view of the structure shown in FIG. 3 after being assembled;

FIG. 5 is a structural schematic diagram of the extension solution of FIG. 3;

FIG. 6 is a sectional view of the structure shown in FIG. 5 after being assembled;

FIG. 7 is another exploded view of a door frame structure according to embodiments of the present disclosure;

FIG. 8 is a partial enlarged view of detail B in FIG. 7;

FIG. 9 is a sectional view of the structure shown in FIG. 8 after being assembled;

FIG. 10 is a schematic cross-sectional view of a side frame according to the embodiments of the present disclosure; and

FIG. 11 is a schematic cross-sectional view of a transom according to the embodiments of the present disclosure.

1—side frame, 11—first side frame, 12—second side frame, 13—groove; 2—corner connector assembly, 21—corner connector, 22—fixing bolt, 23—bolt connecting piece; 3—seam decorative cover; 4—transom, 41—double grooves; 5—U-shaped adhesive strip.

### DETAILED DESCRIPTION OF THE EMBODIMENTS

The technical solutions according to the embodiments of the present disclosure will be clearly and completely described below with reference to the accompanying drawings according to the embodiments of the present disclosure. Obviously, the described embodiments are only a part of the embodiments of the present disclosure, but not all of the embodiments. Based on the embodiments of the present disclosure, all other embodiments obtained by those of ordinary skill in the art without creative efforts shall fall within the protection scope of the present disclosure.

An object of the present disclosure is to provide an assembled door frame. By improving the structure design thereof, the overall assembly accuracy of the door frame is not affected while the simple assembly and the convenient installation are ensured.

In order to make the above objects, features and advantages of the present disclosure more apparent, the present disclosure will be further described in detail below with reference to the accompanying drawings and embodiments.

### First Embodiment

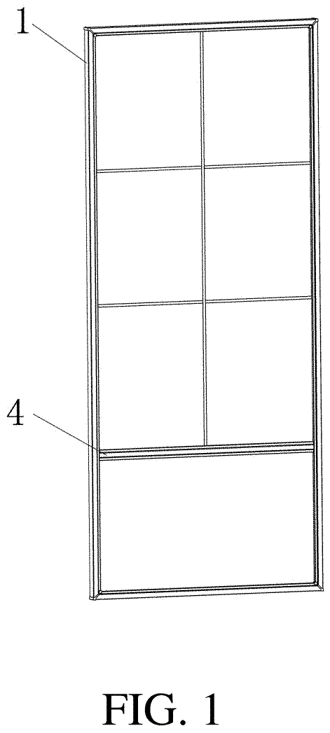

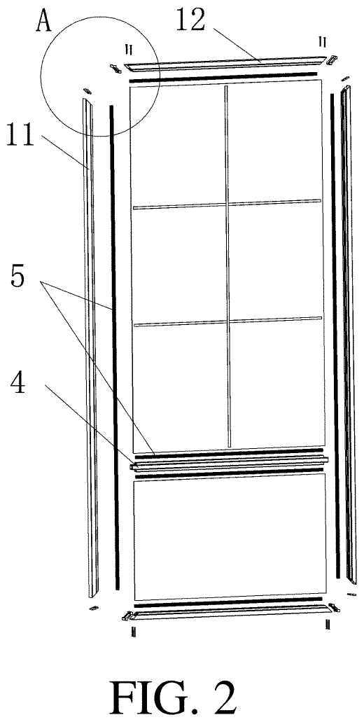

As shown in FIGS. 1 to 6, the present embodiment provides an assembled door frame, the assembled door frame includes several side frames 1 spliced to each other; For the assembly of the corner parts of the door frame, two of the side frames 1 perpendicular to each other are spliced at their ends to form a right-angled side frame of the corner parts of the door frame. Further, every adjacent two of the side frames 1 for right-angle splicing are connected with each other via a corner connector assembly 2.

The corner connector assembly 2 is disposed inside the every adjacent two of the side frames 1 spliced at right angle. The corner connector assembly 2 includes a corner connector 21 and fixing bolts 22. One of the every adjacent two of side frames 1 spliced at right angle is fixed on the corner connector 21 by the fixing bolts 22.

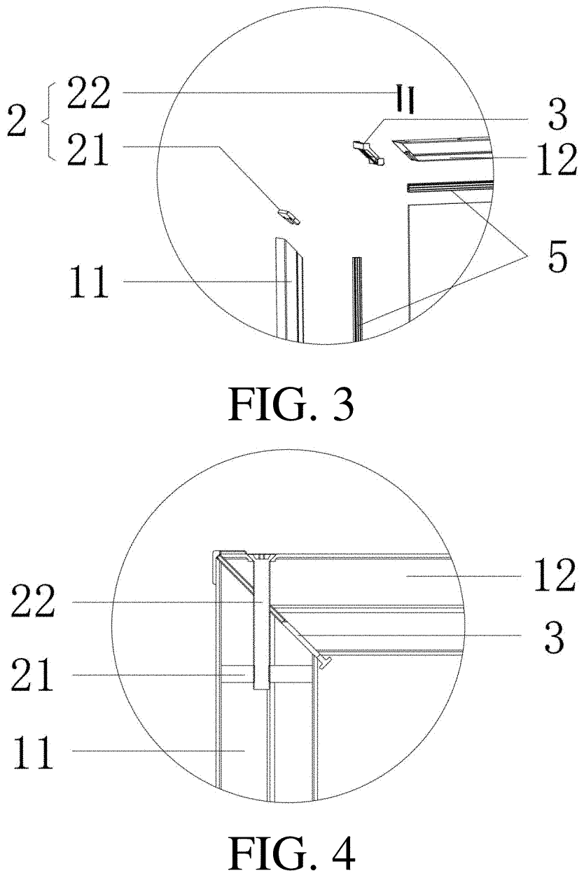

As shown in FIGS. 3 and 4, the corner connector 21 is fixed inside a first side frame 11 which spliced at right angle with a second side frame, and the corner connector 21 can be designed as a block or a sheet structure. In order to facilitate the mounting and fixing of the corner connector 21 inside the first side frame 11, the shape thereof is the same as the cross-sectional shape of the first side frame 11. The corner connector 21 can be fixed by bonding, plugging, welding, and bolting, etc. And the corner connector 21 is provided with first bolt holes for connecting the fixing bolts 22. Second bolt holes are formed in the second side frame 12 corresponding to the first bolt holes, the second bolt hole matches the fixing bolts 22, the second bolt holes and the first bolt holes are coaxial. The length of the fixing bolts 22 is sufficient to connect the first bolt holes and the second bolt holes, countersunk bolts or pan head bolts can be used, and a Philips head or a slotted head can be selected according to practical requirements.

During splicing, each of the fixing bolts 22 is first screwed into the corresponding one of the second bolt holes to be connected to the second side frame 12, and then screwed into the corresponding one of the first bolt holes provided on the corner connector 21, so that the first side frame 11 is connected to the fixing bolts 22 together with the second side frame 12 through the corner connector 21, thereby the right-angle splicing of the first side frame 11 and the second side frame 12 is accomplished.

The side frames 1 are spliced directly together through the respective corner connector assemblies 2 each including the corner connector 21 and the fixing bolts 22. On one hand, the corner connector 21 and the fixing bolts 22 are each disposed within the corresponding side frame 1, such that the original external structure of the side frames 1 will not be changed after the side frames 1 are spliced together, thereby reducing assembly errors of the door frame caused by using the connecting structure. On the other hand, the direct splicing of the side frames 1 is achieved merely by two types of members that are the corner connector 21 and the fixing bolts 22. So, compared with the prior art, a welding process of the side frames is not required, the structure thereof is simple, and the mounting thereof is convenient.

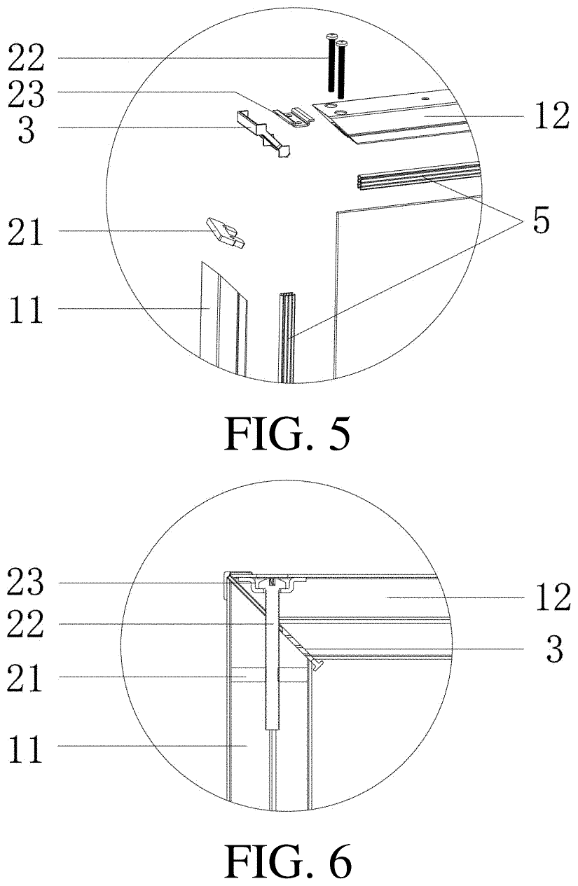

Further, as shown in FIGS. 5 and 6, a bolt connection piece 23 is provided at a connection position between the second side frame 12 and the fixing bolts 22, the bolt connection piece 23 is recessed towards the inside of the second side frame 12, and the second bolt holes are provided on the bolt connection piece 23. The purpose of this structural design is to provide a recess on the second side frame 12 which is enough to accommodate the head of each of the fixing bolts 22, after each of the fixing bolts 22 is screwed into the corresponding one of the second bolt holes, the head of each of the fixing bolts 22 is received in the recess of the bolt connection piece 23. So that the outer contour of the second side frame 12 will not protrude at the connection position between the second side frame 12 and the fixing bolt 22 due to the additional installation of the fixing bolts 22, thereby, an original external structure of the side frames 1 is ensured, and assembly errors of the door frame is reduced.

Further, a seam decorative cover 3 is further arranged on a spliced seam between the first side frame 11 and the second side frame 12 spliced together at a right angle, so that on the basis of making the appearance more beautiful, the seam decorative cover 3 also achieves the effect of splicing and positioning the side frames 1.

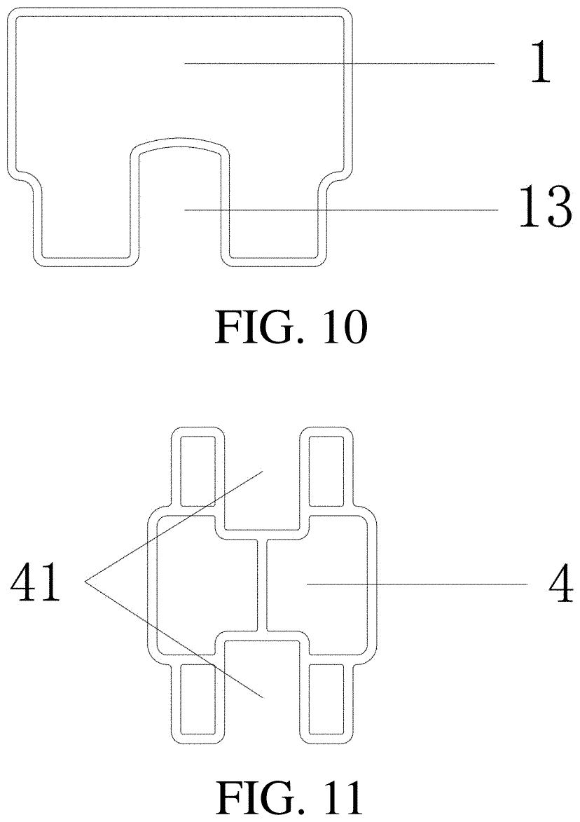

Further, as shown in FIGS. 10 and 11, a groove 13 for receiving a sheet material is provided at an inner side of each of the side frames 1. A transom 4 is arranged between two of the side frames 1 which are parallel to each other. Two ends of the transom 4 are respectively connected to the corresponding two of side frames 1 by plugging, and transom 4 is provided with a bidirectional groove 41 having an H-shaped cross section, so as to enable the sheet material to plug into and fix with the bidirectional groove 41. The groove 13 on each of the side frames 1 and the bidirectional groove 41 of the transom 4 are respectively provided with an U-shaped adhesive strip 5 for fixing the sheet material.

Further, each of the side frames 1 is made of an iron profile, and the strength of the iron profile such as tensile strength, twisting resistance, and bending resistance is stronger than that of the aluminum profile. So, the iron profile with the same strength as the aluminum profile can have a thinner wall thickness, thereby reducing the weight and cost. Because the transom 4 has a relatively complex structure and is suitable for the production of an aluminum extrusion production process, so that the transom 4 is made of an aluminum profile for being easily machined.

### Second Embodiment

The assembled door frame provided by the present embodiment differs from the first embodiment in that the structure design of the corner connector assembly 2 is different.

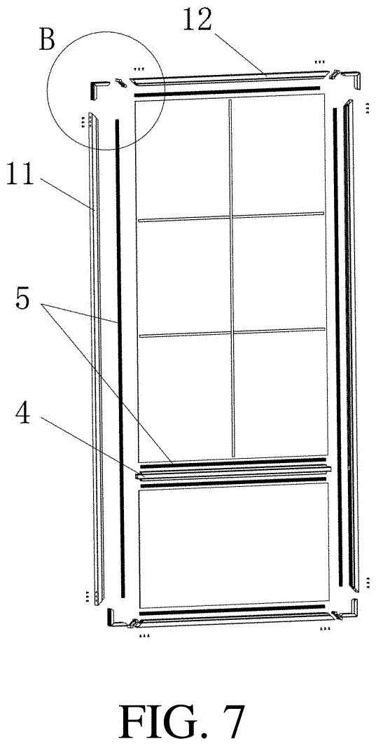

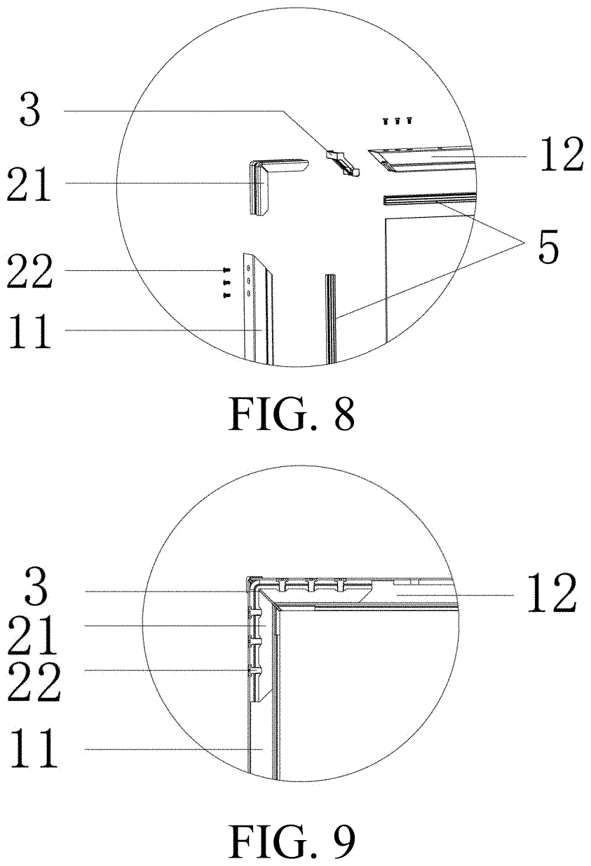

As shown in FIGS. 7 to 9, according to the present embodiment, the corner connector 21 of the corner connector assembly 2 is of a right-angle fixing structure, and two right-angle sides of the right-angle fixing piece structure are respectively provided with several bolt holes. Bolt holes corresponding to bolt holes provided on the corner connector 21 are also respectively provided on the first side frame 11 and the second side frame 12 which are spliced at right angle.

During splicing, the first side frame 11 and the second side frame 12 are respectively sleeved on the two right-angle sides of the corner connector 21, and the bolt holes provided on the first side frame 11 and the second side frame 12 are respectively aligned with the bolt holes provided on the corner connector 21. After that, the fixing bolts 21 are screwed into the bolt holes to fix the first side frame 11 and the second side frame 12 at the two right-angle sides of the corner connector 21 respectively to complete the splicing of the first side frame 11 and the second side frame 12.

It should be noted that, for those skilled in the art, it is obvious that the present disclosure is not limited to the details of the above exemplary embodiments, and the present disclosure can be implemented in other specific forms without departing from the spirit or essential characteristics of the present disclosure. Therefore, it is intended that the embodiments be considered in all respects as illustrative and not restrictive, the scope of the invention being indicated by the appended claims rather than by the foregoing description, and all changes that come within the meaning and range of equivalency of the claims are therefore intended to be embraced therein. Any reference numbers in the claims shall not be construed as limiting the claims referred to.

1. An assembled door frame, comprising a plurality of side frames spliced together, wherein every adjacent two of the side frames spliced at right angle are connected via a corner connector assembly; the corner connector assembly is arranged inside the every adjacent two of the side frames spliced at right angle; the corner connector assembly comprises a corner connector and fixing bolts, and one of the every adjacent two of side frames spliced at right angle is fixed on the corner connector by the fixing bolts.

2. The assembled door frame according to claim 1, wherein the corner connector is fixed inside a first side frame of the every adjacent two of side frames spliced at right angle; and a second side frame of the every adjacent two of side frames is fixed on the corner connector by the fixing bolts.

3. The assembled door frame according to claim 2, wherein first bolt holes are formed in the corner connector, and second bolt holes are formed in the second side frame; each of the fixing bolts is connected to the second side frame through a corresponding one of the second bolt holes, so as to connect to a corresponding one of the first bolt holes to fix the second side frame on the corner connector.

4. The assembled door frame as claimed in claim 3, wherein a bolt connection piece is provided on the second side frame, the bolt connection piece is recessed towards an inside of the second side frame, and the second bolt holes are provided on the bolt connection piece.

5. The assembled door frame according to claim 1, wherein the corner connector is of a right-angle fixing structure; the every adjacent two of the side frames spliced at right angle are respectively provided with bolt holes, and the every adjacent two of the side frames are fixed on two right-angle sides of the corner connector respectively by the fixing bolts each of which passes through a corresponding one of the bolt holes.

6. The assembled door frame according to claim 1, wherein a seam decorative cover is provided on a splicing seam of the every adjacent two of the side frames spliced at right angle.

7. The assembled door frame according to claim 6, wherein an inner side of each of the side frames is provided with a groove for receiving a sheet material.

8. The assembled door frame according to claim 7, wherein a transom is provided between two of the side frames which are parallel to each other; two ends of the transom are plugged into the two of the side frames respectively; and the transom is provided with a bidirectional groove having an H-shaped cross section, so as to enable the sheet material to plug into and fix with the bidirectional groove.

9. The assembled door frame as claimed in claim 8, wherein the groove on each of the side frames and the bidirectional groove of the transom are respectively provided with an U-shaped adhesive strip for fixing the sheet material.

10. The assembled door frame according to claim 9, wherein each of the side frames is made of an iron profile, and the transom is made of an aluminum profile.

11. The assembled door frame according to claim 2, wherein a seam decorative cover is provided on a splicing seam of the every adjacent two of the side frames spliced at right angle.

12. The assembled door frame according to claim 11, wherein an inner side of each of the side frames is provided with a groove for receiving a sheet material.

13. The assembled door frame according to claim 12, wherein a transom is provided between two of the side frames which are parallel to each other; two ends of the transom are plugged into the two of the side frames respectively; and the transom is provided with a bidirectional groove having an H-shaped cross section, so as to enable the sheet material to plug into and fix with the bidirectional groove.

14. The assembled door frame as claimed in claim 13, wherein the groove on each of the side frames and the bidirectional groove of the transom are respectively provided with an U-shaped adhesive strip for fixing the sheet material.

15. The assembled door frame according to claim 14, wherein each of the side frames is made of an iron profile, and the transom is made of an aluminum profile.

16. The assembled door frame according to claim 5, wherein a seam decorative cover is provided on a splicing seam of the every adjacent two of the side frames spliced at right angle.

17. The assembled door frame according to claim 16, wherein an inner side of each of the side frames is provided with a groove for receiving a sheet material.

18. The assembled door frame according to claim 17, wherein a transom is provided between two of the side frames which are parallel to each other; two ends of the transom are plugged into the two of the side frames respectively; and the transom is provided with a bidirectional groove having an H-shaped cross section, so as to enable the sheet material to plug into and fix with the bidirectional groove.

19. The assembled door frame as claimed in claim 18, wherein the groove on each of the side frames and the bidirectional groove of the transom are respectively provided with an U-shaped adhesive strip for fixing the sheet material.

20. The assembled door frame according to claim 19, wherein each of the side frames is made of an iron profile, and the transom is made of an aluminum profile.
